(19) United States
(12) Patent Application Publication
(10) Pub. No.: US 2023/0067171 A1
(43) Pub. Date: Mar. 2, 2023

(54) ELECTRONIC SHIFT CONTROL SYSTEM FOR A BICYCLE

(71) Applicant: SRAM, LLC, Chicago, IL (US)

(72) Inventor: JOSHUA BROWN, CHICAGO, IL (US)

(73) Assignee: SRAM, LLC, Chicago, IL (US)

(21) Appl. No.: 17/412,878

(22) Filed: Aug. 26, 2021

(51) Int. Cl. B62M 25/08; B62L 3/02; B62J 45/20; B62J 43/30; G08C 17/02

(52) U.S. Cl. CPC B62M 25/08; B62L 3/02; B62J 45/20; B62J 43/30; G08C 17/02

(57) ABSTRACT

An electronic shift control system includes a first bicycle control device including a first housing, a first brake lever, and a first switch configured to generate a first signal when actuated. The electronic shift control system additionally includes a second bicycle control device including a second housing, a second brake lever, and a second switch configured to generate a second signal when actuated. The first bicycle control device is configured to wirelessly transmit both the first signal and the second signal.

### BACKGROUND

### Field of the Disclosure

The present disclosure is generally directed to a bicycle control device, and more particularly to a bicycle control device that includes a brake lever and an electronic shift control system for mounting to a handlebar of a bicycle.

### Description of Related Art

A typical electronic shift control system for a bicycle, includes two bicycle control devices located on the handlebars of the bicycle. Each bicycle control device typically includes a primary actuating button located adjacent to the brake lever and a way of transmitting shift signals wirelessly. Further, each bicycle control device includes a battery unit and jacks packaged together on a fully equipped circuit board assembly.

However, the number of repeated components in the electronic shift control system increases cost and limits the placement options for these components and other components on the device. Accordingly, there is a need for a simplified electronic shift control system.

### SUMMARY

An electronic shift control system is disclosed herein and includes a first bicycle control device including a first housing, a first brake lever, and a first switch configured to generate a first signal when actuated. The electronic shift control system additionally includes a second bicycle control device including a second housing, a second brake lever, and a second switch configured to generate a second signal when actuated. The first bicycle control device is configured to wirelessly transmit both the first signal and the second signal.

### BRIEF DESCRIPTION OF THE DRAWINGS

Objects, features, and advantages of the present invention will become apparent upon reading the following description in conjunction with the drawing figures, in which:

FIG. 1 shows a side view of a bicycle according to the present disclosure.

FIG. 2 shows a rear and outside perspective view of the first control device and a portion of the handlebar of the bicycle depicted in FIG. 1.

FIG. 3 shows a front view of the first control device of FIG. 2.

FIG. 4 shows an outside view of the first control device of FIG. 2.

FIG. 5 shows a top view of the first control device of FIG. 2.

FIG. 6 shows an inside bottom perspective view of the first control device of FIG. 2.

FIG. 7 shows the first control device of FIG. 6, but with an outer cover removed.

FIG. 8 shows an outside bottom perspective view of the first control device of FIG. 7.

FIG. 9 shows a cross section taken along line 9-9 of the brake lever and shift lever assembly of the first control device of FIG. 3.

FIG. 10 shows a cross section taken along line 10-10 of the brake lever and shift lever assembly of the first control device of FIG. 9.

FIG. 11 shows a partial exploded view of the first control device of FIGS. 7 and 8.

FIG. 12 shows a further exploded view of the first control device of FIGS. 7 and 8.

FIG. 13 shows a rear perspective view of the shift lever assembly of the first control device of FIG. 11.

FIG. 14 shows an exploded perspective view of a portion of the shift lever assembly of FIG. 13.

FIG. 15 shows an exploded bottom perspective view of a battery unit of the shift lever assembly of FIGS. 11-13.

FIG. 16 shows a top perspective view of the battery unit of FIG. 15.

FIG. 17 shows a cross section taken along line 17-17 of the first control device of FIG. 3.

FIG. 18 shows a bottom perspective view of a housing portion of the first control device of FIG. 7.

FIG. 19 shows the housing portion of FIG. 18, but with the battery unit removed.

FIG. 20 shows the housing portion of FIG. 19, but with a battery receptacle of the battery unit installed in the housing.

FIG. 21 shows an inside front perspective view of the first control device of FIG. 7.

FIG. 22 shows a top perspective view of the housing portion of FIGS. 18-20.

FIG. 23 shows the housing portion of FIG. 22, but with protective covers installed on parts or regions of the housing.

FIG. 24 shows an assembled perspective view of the shift lever portion of the shift lever assembly of FIG. 14.

FIG. 25 shows a partial exploded view of the shift lever portion of FIG. 24.

FIG. 26 shows a bottom view of the handlebar including an electronic shift control system having the first control device and the second control device.

FIG. 27 shows a perspective view of the handlebar including the second control device partially disassembled.

FIG. 28 shows a side view of the second control device.

FIG. 29A shows a first side of a printed circuit board within the second control device.

FIG. 29B shows a second side of the printed circuit board within the second control device.

### DETAILED DESCRIPTION OF THE DISCLOSURE

A bicycle control device is disclosed herein that solves or improves upon one or more of the above-mentioned and/or other problems and disadvantages with prior known control devices. The disclosed an electronic shift control system having a first bicycle control device and a second bicycle control device, each including a brake lever and housing and mounted to a handlebar of a bicycle. The brake levers of the control devices may be for operating a hydraulic brake system or a mechanical cable brake system. The first bicycle control device is configured to wirelessly transmit shift signals, has a battery unit, and includes accessory ports, or jacks, for connecting to the second bicycle control device and/or remote shift control devices or buttons located elsewhere on the bicycle. The accessory ports may be configured as input ports to receive input signals from the second bicycle control device and/or the remote shift control devices.

Those having ordinary skill in the art should understand that the drawings and detailed description provided herein are for illustration only and do not limit the scope of the invention or the disclosure. The appended claims define the scope of the invention and the disclosure. The terms “first”, “second,” and the like, as well as “front”, “rear,” “left”, “right”, and the like are used for the sake of clarity. Such terms and similar terms are not used herein as terms of limitation. Further, such terms refer to bicycle mechanisms that are conventionally mounted to a bicycle and with the bicycle oriented and used in a standard manner, unless otherwise indicated.

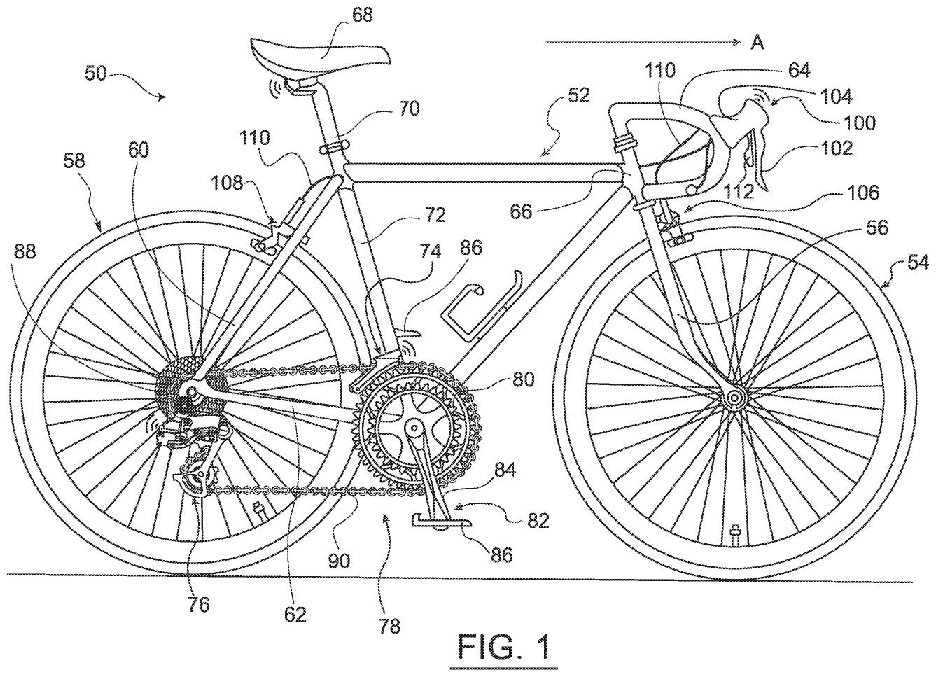

Turning now to the drawings, FIG. 1 depicts a bicycle 50 with a frame 52, a front wheel 54 coupled to a fork 56 of the frame, and a rear wheel 58 coupled to seat stays 60 and chain stays 62 of the frame. The wheels 54, 58 support the frame 52 above a surface on which the bicycle 50 can travel in a forward direction indicated by the arrow ‘A’. The bicycle 50 has a drop-bar type handlebar 64 that is mounted to a head tube 66 of the frame 52. The bicycle 50 also has a seat 68 carried by a seat post 70 received in a seat tube 72 of the frame 50. The bicycle 50 may have one or both of a front gear changer 74 and a rear gear changer 76 mounted to the frame 52. The gear changers 74, 76 may be electromechanical derailleurs, for example. The bicycle 50 includes a multiple-geared drive train 78 with one or more chainrings 80 driven by a crank assembly 82, which has two crank arms 84 and two pedals, respectively 86. The chainrings 80 may be connected to a plurality of sprockets 88 at the rear wheel 58 by a chain 90.

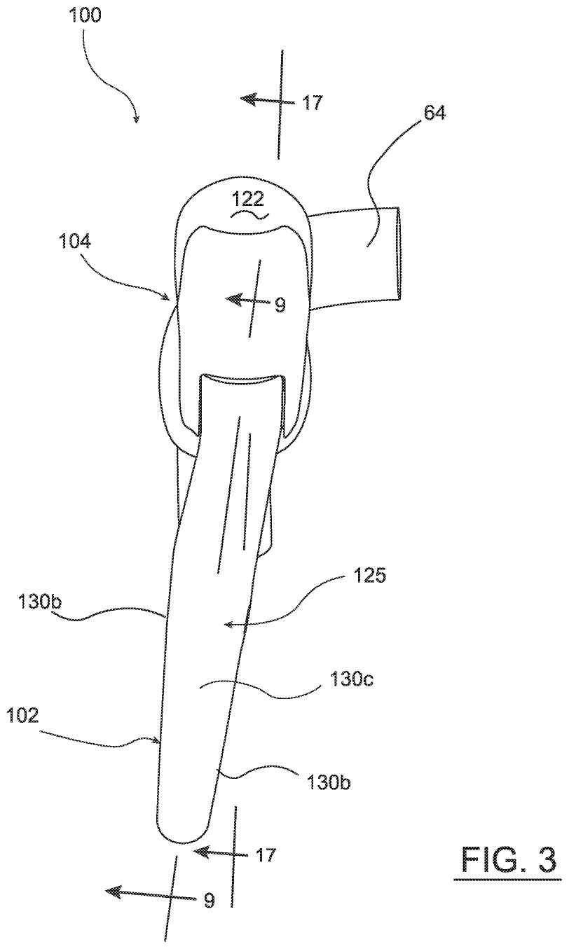

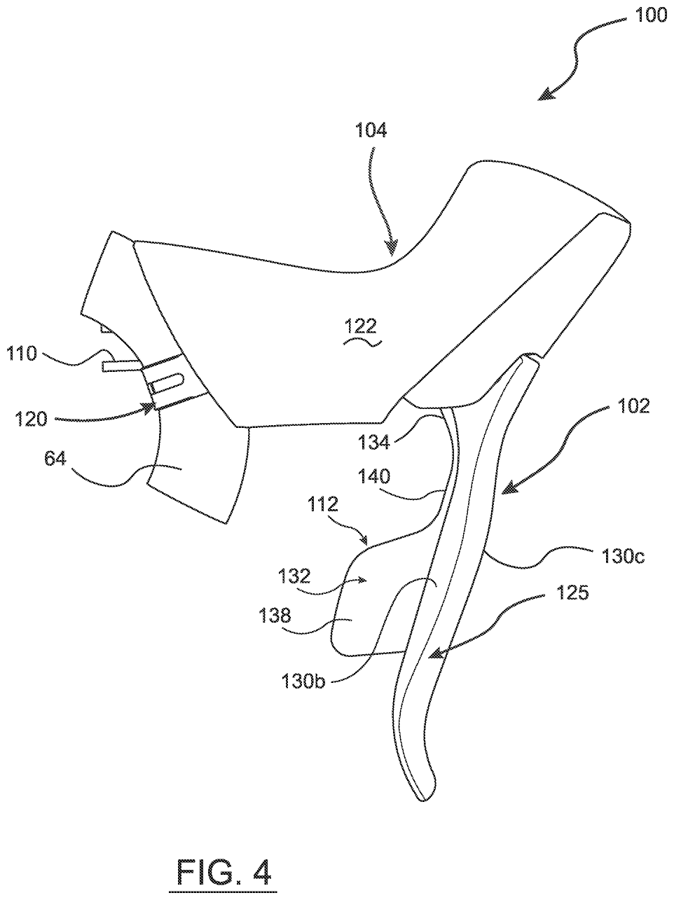

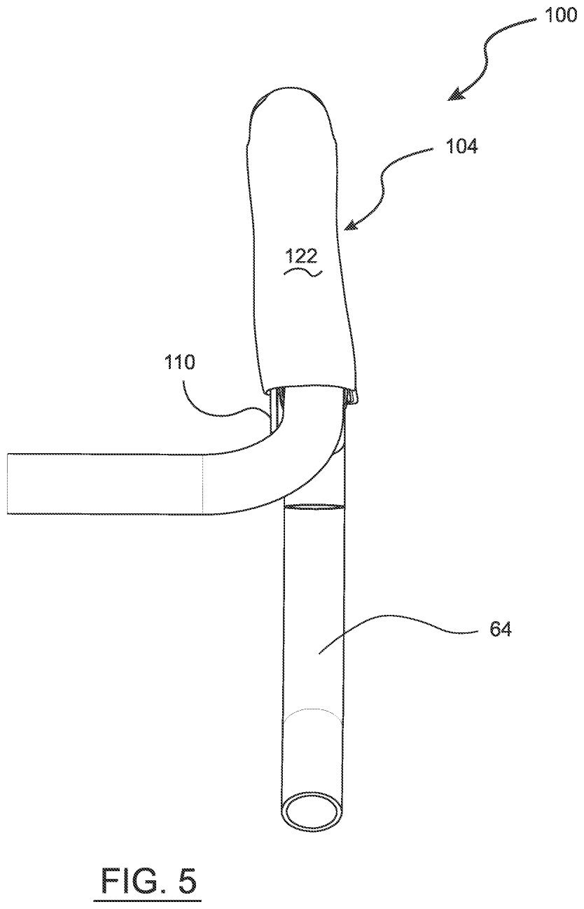

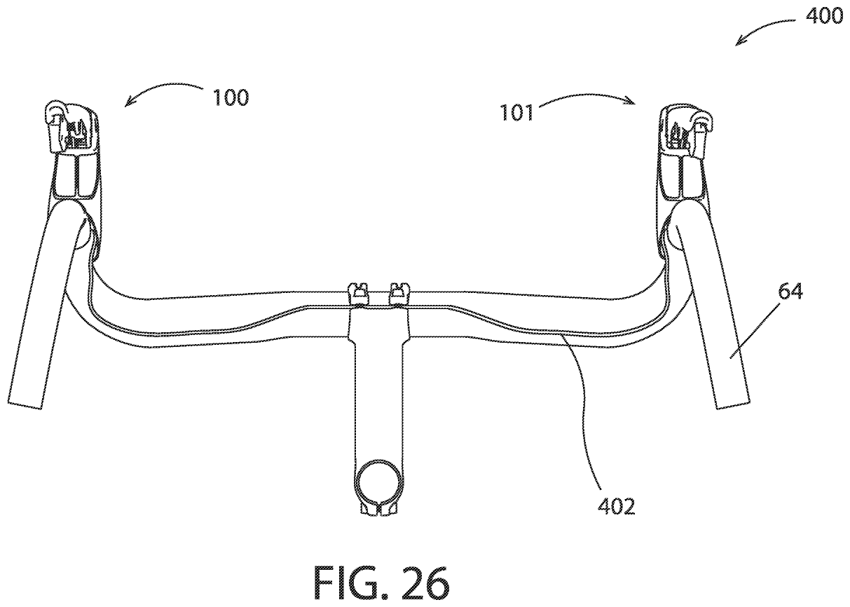

Referring to FIGS. 1-5, the bicycle 50 in the disclosed example has at least one first bicycle control device 100, hereinafter the “first control device 100”, which can be mounted to the handlebar 64. Further, the bicycle 50 in the disclosed example, has at least one second bicycle control device 101 seen in FIGS. 26-29B, hereinafter the “second control device 101”, which can be mounted on the handlebar 64. The first control device 100 and the second control device 101 are connected by a cable 402 that transmits signals generated at the second control device 101 to the first control device 100 for wireless transmission from the first control device 100. In this example, the first control device 100 includes a brake control element of a brake system. The brake control element includes a brake lever 102 that is movably connected to a hood or housing 104 of the device. The brake lever 102 operates components of the braking system of the bicycle 50. In one example, the brake system can include one or both of a hydraulic front brake mechanism 106 coupled to the front wheel 54 and a hydraulic rear brake mechanism 108 coupled to the rear wheel through hydraulic lines 110. As noted above, the brake system can instead be a mechanical cable type brake system. As described in greater detail below, the first control device 100 also includes a shift control element of an electronic shift control system. The shift control element includes a shift lever assembly 112 for shifting the gears of the bicycle 50.

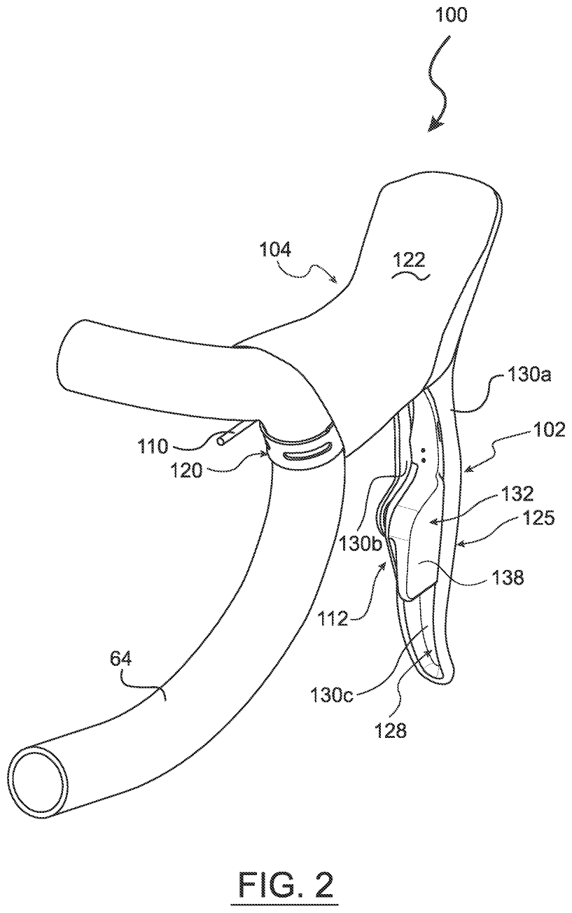

Referring to FIGS. 2-6, various exterior views are depicted of the first control device 100, which is constructed according to one example of the present disclosure. The first control device 100 is mountable to the handlebar 64. In one example, the housing 104 can incorporate and include a known type of clamp 120, which may be or include an adjustable band that extends around the handlebar. In one example, the bicycle 50 may include a second control device 101. The first control device 100 and the second control device 101 are located on the handlebar 64, one on each of the left and right sides. One having ordinary skill in the art should understand that together the pair of control devices 100, 101 may be configured to operate the respective front and rear electromechanical derailleurs 74, 76 and the respective front and rear brake mechanisms 106, 108. In an example, the first control device 100 and the second control device 101 may be configured to operate the rear derailleur 76, operation of one of the first control device 100 and the second control device 101 causing an upshift and the other causing a downshift.

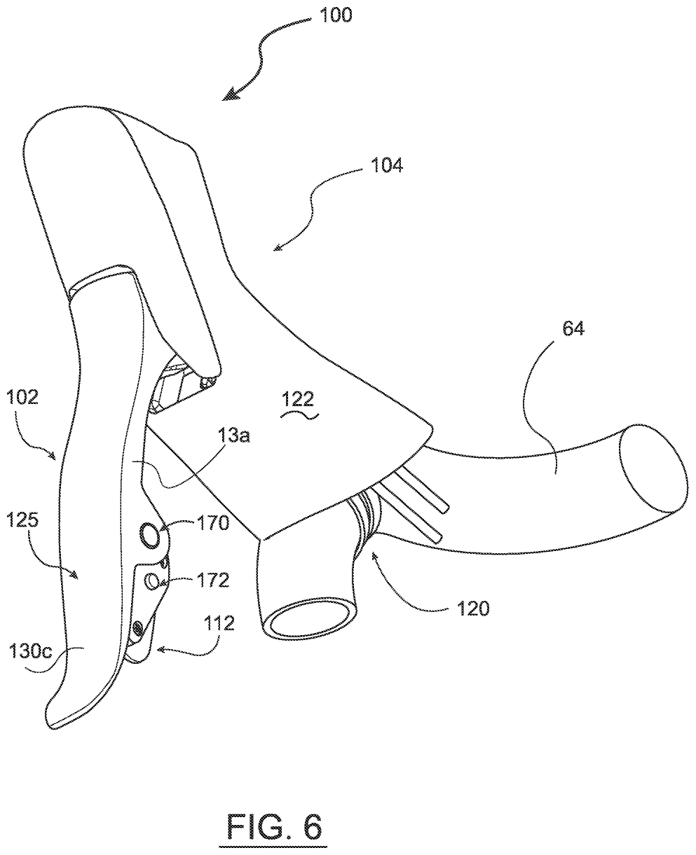

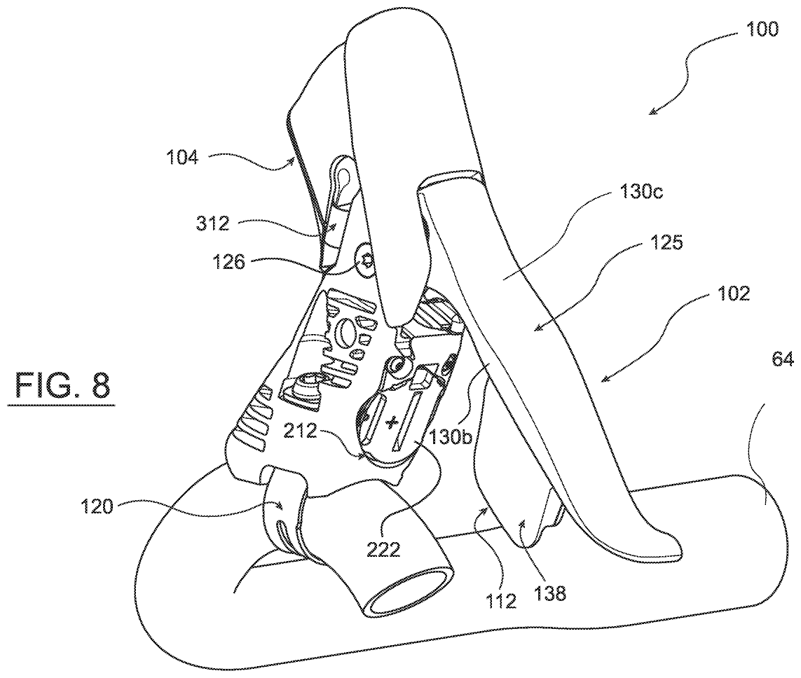

In the disclosed example, referring to FIGS. 6-8, the first control device 100 includes a hood, i.e., the housing 104, which may be covered with an exterior or outer cover 122. The housing 104 is shaped and sized to be grasped by a hand of a user or rider and the outer cover 122 can be configured to closely follow and overlie the shape of the housing. The housing 104 and outer cover 122 can serve as a grip or can together be configured as a graspable portion of the first control device 100. The housing 104 may be formed of any suitable material, such as for example, metal, plastic, and/or composite materials. The housing 104 is constructed to carry, house, and/or support the various components and mechanisms of the control elements of the brake system and the shift control system, as described in greater detail below. The outer cover 122 may be made of any suitable material, such as natural and/or synthetic elastomeric materials and may be designed to present a comfortable interface with the user and to reduce the tendency to become detached or moved from its position on the exterior of the housing 104. For example, the outer cover 122 may be formed of a flexible thermoplastic elastomer (TPE) such as Santoprene™. The outer cover 122 may be configured to be removably attached to and held in position on the housing 104 using any known securement or attachment method.

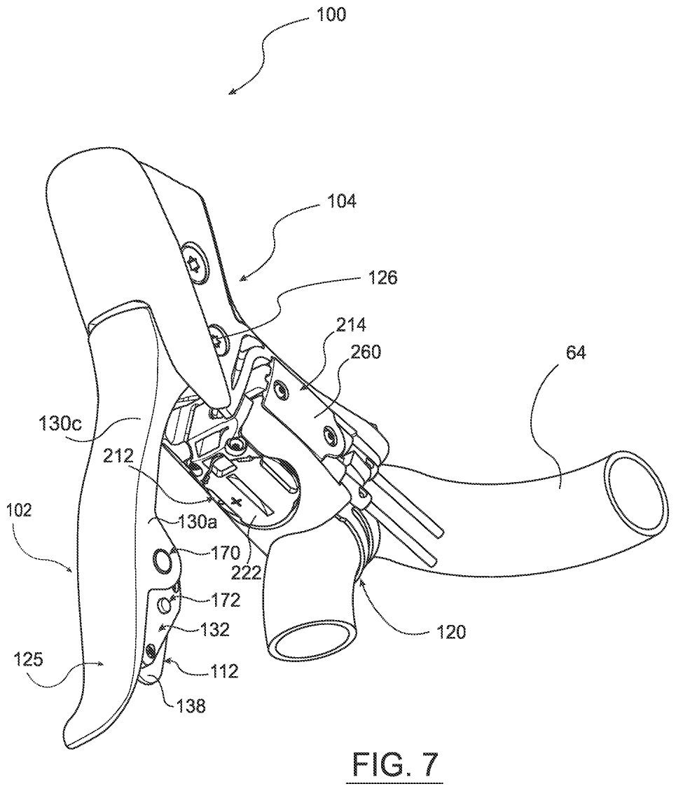

In this example, referring to FIGS. 7-9 wherein the outer cover 122 has been removed, the brake lever 102 is pivotally or movably attached to the housing 104. The brake lever 102 may be attached to the housing 104 at or near the leading or front part of the housing so that the brake lever is spaced forward from the handlebar 64. The brake lever 102 may thus be pivotable relative to the housing 104 generally forward and rearward. The brake lever 102 may also be made of any suitable material such as metal, plastic, or composite materials. The brake lever 102 may include a pivot bore or holes 124 near the proximal end. The pivot holes 124 can be aligned with one another and define a pivot axis P that is oriented generally perpendicular to the lengthwise axis of a grip handle 125 of the brake lever 102. The brake lever 102 can be attached to the housing 100 by an axle 126, which may in the form of a pivot pin, a rod, a shaft, or the like, through the holes 124.

In the disclosed example, referring to FIG. 2, the brake lever 102 may have a U-shaped recess or define a channel 128 along at least a lengthwise portion of the grip handle 125. The shift lever assembly 112 may be positioned in a nested arrangement at least partially within the recess or channel 128, as described in more detail below. This nested arrangement of the shift lever assembly 112 with the brake lever 102, and the U-shape of the lever body, can impart some rigidity to the structure and may provide protection for components disposed within the channel. The shift lever assembly 112 may also be pivotally or movably attached to the housing 100, to a pivot mechanism, or to the brake lever 102. The shift lever assembly 112 may be positioned behind the brake lever 102, i.e., between the brake lever and the handlebar 64 when installed on the bicycle 50. The shift lever assembly 112 may also be made of any suitable materials, such as plastic or composite materials. In one example, the shift lever assembly 112 should be made, at least in part, from a material that does not significantly inhibit wirelessly transmitted signals from penetrating the material.

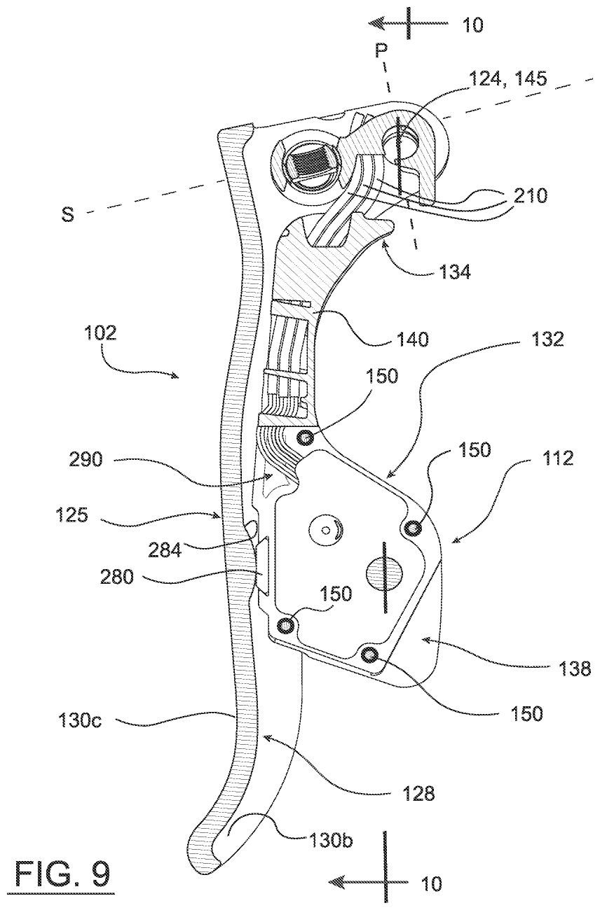

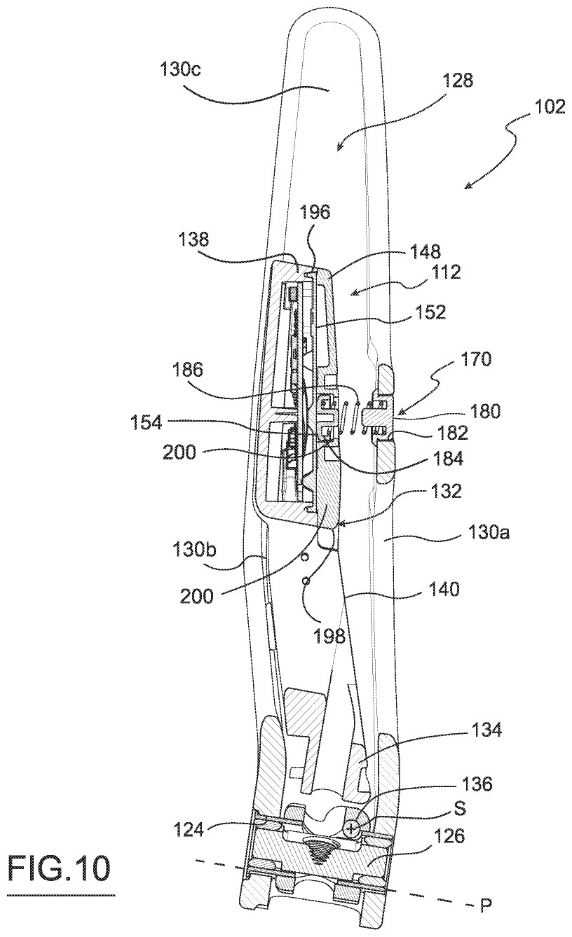

FIGS. 9 and 10 depict cross sections of the brake lever 102 and the shift lever assembly 112 in an assembled or in-use arrangement. Referring to FIGS. 2, 9, and 10, the channel 128 of the brake lever 102 is defined between spaced apart side walls including an inside wall 130a and an outside wall 130b, with reference to the orientation of the bicycle 50, and within a front facing wall 130c. The shift lever assembly is nested in the channel 128. As described in further detail below, the shift lever assembly 112 can pivot laterally in a direction between the side walls 130a, 130b about an axis S that is generally perpendicular to the pivot axis P of the brake lever 102 about the axle 126. Thus, the shift lever assembly 112 can move in inboard and outboard directions relative to the bicycle 50 while staying nested and aligned with the brake lever 102.

In general, referring to FIGS. 9-11, the shift lever assembly 112 has a shift lever 132 including a proximal end 134 that is directly or indirectly pivotally attached to the housing 104 or the brake lever 102 by a pivot pin 136, which defines the pivot axis S of the shift lever assembly. The shift lever 132 also has a distal or paddle end 138 that is opposite the proximal end and an elongate lever arm 140 connecting the proximal and distal ends. The lever arm 140 may be a closed hollow body or may be U-shaped or open sided and can include structural ribbing therein.

In one example, the proximal end 134 of the shift lever 132 may also have a transverse opening 142 that is positioned to accommodate the pivot axle 126 of the brake lever 102 passing through the shift lever assembly 112. The proximal end 134 of the shift lever 132 may also carry connecting components (not described in detail herein) for connecting the brake lever 102 to the hydraulic brake system. Those components can include a sleeve 144 carried by the shift lever 132 and spaced from and parallel to the transverse opening 142. When the shift lever assembly 112 is assembled to the brake lever 102, the sleeve is received in a set of openings 145 at the proximal end of the brake lever 102, which are spaced from the pivot bore 124. The combination of the sleeve 144 and openings 145, along with the transverse opening 142 and the axle 126, marries the brake lever 102 and the shift lever assembly 112 together relative to the brake lever pivot axis P. The shift lever assembly 112 is thus configured to move in concert with the brake lever 102 about the pivot axis P when the brake system is operated, but moves independent of the brake lever when the shift control system is operated. As describe in more detail below, the paddle end 138 of the shift lever 132 includes an interior cavity 146 that houses electronic components of the shift lever assembly 112 and the shift control system.

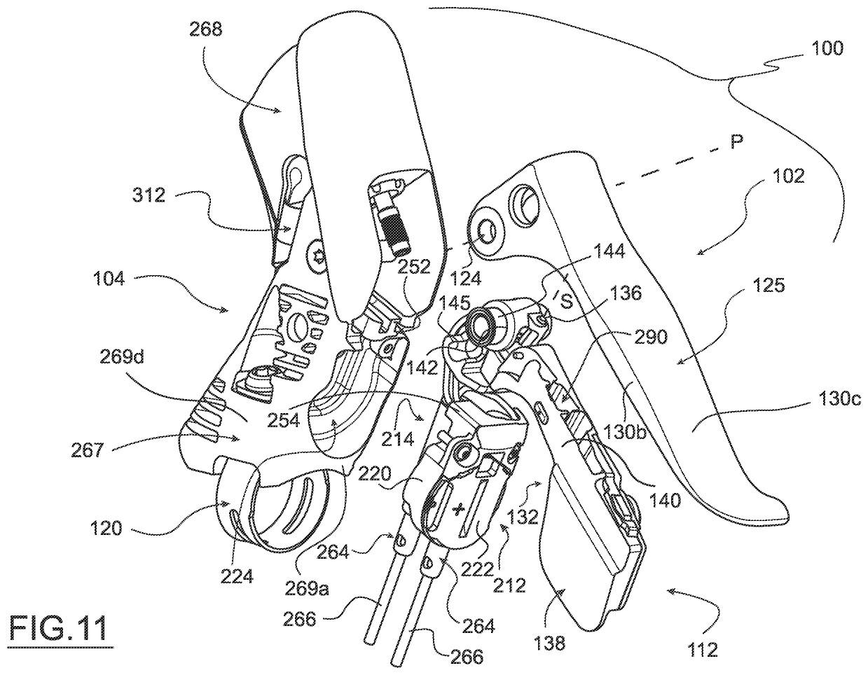

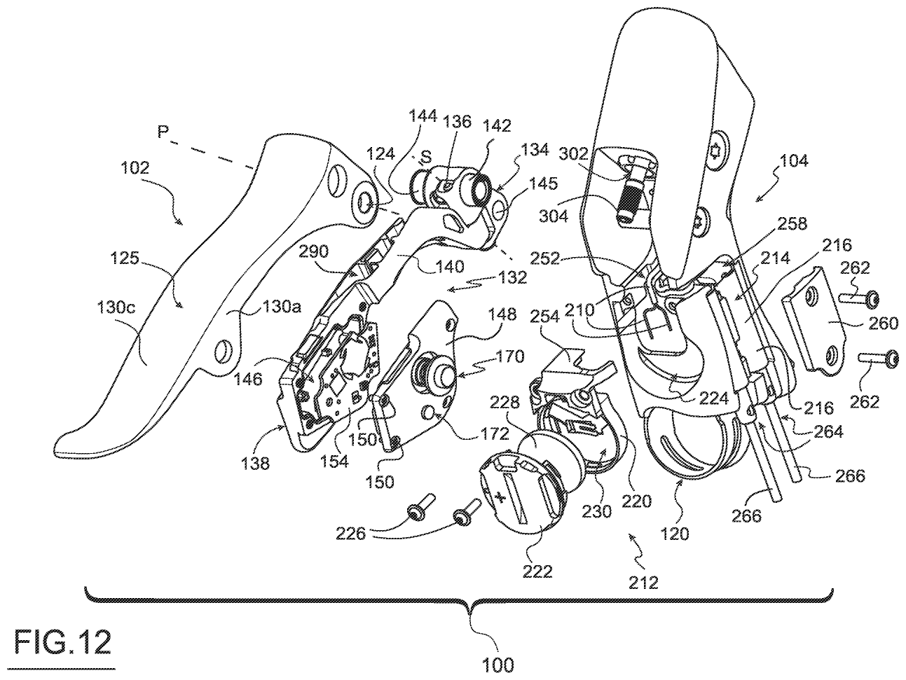

Referring to FIGS. 11 and 12, the first control device 100 has four primary parts including the housing 104, the outer cover 122 (not shown, see FIG. 6), the brake lever 102, and the shift lever assembly 112. The shift lever assembly 112 and the housing 104 each further include additional sub-components according to the teachings of the present invention and as illustrated generally in FIG. 12.

In the disclosed example, referring to FIGS. 11-14, the shift lever assembly 112 is a self-contained electrical assembly, which provides several advantages and improvements, as described below, over prior known bicycle control devices of this type. In this example, the shift lever assembly 112 includes electronic componentry for operating the first control device 100. Some of the electronic componentry in this example is housed within the interior cavity 146 in the paddle end 138 of the shift lever 132 and some of the componentry is external to but electrically connected with the componentry within the cavity.

The paddle end 138 of the shift lever 132 in this example has a larger surface area than the adjoining lever arm 140. The paddle end 138 thus provides a convenient and ergonomic contact point for a user. The interior cavity 146 includes a cover 148, which can be secured by fasteners 150 to the paddle end 138 to close off the cavity and exclude water and other contaminants from entry into the cavity. A seal 152 may be interposed between the interior cavity 146 and the cover 148. The seal 152 may be a rubber seal membrane or layer or any suitable material that satisfactorily seals the cavity 146 to prevent ingress of moisture or contaminants.

In one example, a printed circuit board (PCB) 154 is disposed within the sealed cavity 146. Various electronic componentry may be mounted on or connected to the PCB 154. The PCB 154 may include a communication module 156 configured to transmit signals from the first control device 100. In one example, the communication module 156 may be configured for wireless transmission of signals in the form of electromagnetic radiation (EMR), such as radio waves or radio frequency signals. Optionally, the communication module 156 may also be configured to receive signals. In one example, the communication module 156 may be configured to receive signals, which may be in the form of EMR such as radio waves or radio frequency signals. The communications module 156 can include or can be a transmitter or a transceiver. The PCB 154 may also include an antenna 158 that is in operative communication with the communication module 156 to send and optionally also receive EMR signals. The antenna 158 may be any device designed to transmit and/or receive electromagnetic radiation (e.g. TV or radio) waves.

In the disclosed example, the antenna 158 is on the PCB 154 in a position where it will be able to send signals without significant interference from the structure of the first control device 100 and/or from a user's hand. In another example, to help reduce or prevent interference, the antenna 158 may be a wireless antenna and may be positioned, at least in part, in or on a portion of the first control device 100 that is separate and remote or spaced from the housing 104. The antenna 158 may be positioned on another part of the brake lever 102 or the shift lever 132, for example.

The first control device 100 also includes a controller 160, which in this example is also on the PCB 154. The controller 160 is operatively connected to the communication module 156 to perform electronic operations such as generating the signals related to one or more of shifting, pairing, derailleur trim operations, power management, and the like. The controller 160 may be programmable and configurable to generate signals to control the front and rear derailleurs 74, 76, for example. In one example, the controller 160 may be an Atmel ATmega324PA microcontroller with an internal EEPROM memory. The communication module 156 may also be programmable and configurable to likewise to transmit and/or receive signals to control the front and rear derailleurs 74, 76. In one example, the communication module 156 may be an Atmel AT86RF231 2.4 GHz transceiver utilizing AES encryption and DSS spread spectrum technology supporting 16 channels and the IEEE 802.15.4 communication protocol. However, other suitable microcontrollers 160 and communications modules 156 may be utilized. Additionally, ancillary electrical and/or electronic devices and components may be used, as is well known in the art, to further enhance or enable the function and operation of the controller 160 and the communications module 156 and related components.

In one example, the first control device 100 may include at least one light emitting diode (LED) 162, which may also be positioned on the PCB 154. The LED 162 may convey status information to a user or a rider relating to the electronic componentry and function of the shift lever assembly 112 or first control device 100. The LED 162 in this example is visible through a transparent part 164 of the seal 152 and a window or opening 166 in the cover 148 of the cavity 146. In one example, the entire seal 152 may be transparent. Alternatively, only the part 164 of the seal material is configured to permits light through the seal.

Further, the electronic componentry may include one or more electrical switches 170, 172. The electrical switches 170, 172, when actuated, may cause operations to be carried out by the controller 160. Such operations may relate to signal transmission or reception, derailleur, and first control device 100 pairing, trim and/or shift operations, and the like. The switches 170, 172 may generate signals to initiate or elicit an action and/or response from various mechanisms of the bicycle 50, such as the front and rear electromechanical derailleurs 74, 76.

In this example, the first electrical switch 170 includes a contact (not shown) on the PCB 154 underlying a resilient dome switch element 174, also on the PCB. In this example, the first electrical switch 170 is actuated through the seal 152 from outside the cavity 146 and the shift lever 132. The cover 148 has a first switch opening 176, where both the cover and the opening are on the inward facing side of the shift lever 132, i.e., the non-actuation side of the paddle end 138. An actuator 178 is seated in the first switch opening 176, as depicted in FIGS. 6, 10, and 12. The actuator 178 includes a button 180 that is received in a hole 182 in the inside wall 130a of the brake lever 102. A spring retainer 184 is retained in the first switch opening 176 in the cover 148. A spring 186 extends between the button 180 and the retainer 184 and biases the shift lever toward the outside wall 130b of the brake lever 102, as depicted in FIG. 10. A user or rider operates the shift lever 132 by pushing inward on the actuation surface, i.e., outside surface of the paddle end 138 against the bias force of the spring 186. As the rider pushes on the paddle end 138, the button 180 will eventually contact the spring retainer 184. Through the seal 152, the spring retainer 184 will push against the domed switch element 174, which will further touch the contact on the PCB 154 to close and actuate the first electrical switch 170.

The second electrical switch 172 includes a contact 190 on the PCB 154. The contact 190 may be a domed switch element or a pressure type switch contact. In this example, the second electrical switch 172 is also actuated through the seal 152 from outside the cavity 146 and the shift lever 132. The cover 148 has a second switch opening 192, where both the cover and the opening are again on the inward facing side of the shift lever 132, i.e., the non-actuation side of the paddle end 138. A button 194 extends through and is seated in the second switch opening 192 in the cover 148, as depicted in FIG. 6. The button 194 may be integrally formed as a part of the seal 152 or may be attached to the seal material. A user or rider operates the second electrical switch 172 simply by depressing the button 194 toward the cover 148. The button 194 or the underlying material layer of the seal 152, may have a point contact (not shown) on the inside end, which pushes against the seal 152 to depress and close the contact 190 to actuate the second electrical switch 172.

The buttons 180 and 194 operate through the material layer of the seal 152, whereby the integrity of the seal for the cavity 146 is not compromised. Other types of electrical switches may be used. The first electrical switch 170 may be used for operating the first control device 100 on a frequent and more forceful basis, such as to initiation of a gear shift or gear change. The second electrical switch 172 may be an optional switch and in this example, may be smaller and more self-contained. The second electrical switch 172 may be intended to be used less frequently than the first electrical switch 170. In one example, the second electrical switch 172 may be used for operations related to pairing the bicycle control device with a specific bicycle component, such as the front or rear electromechanical derailleurs 74, 76, or for trimming the derailleurs.

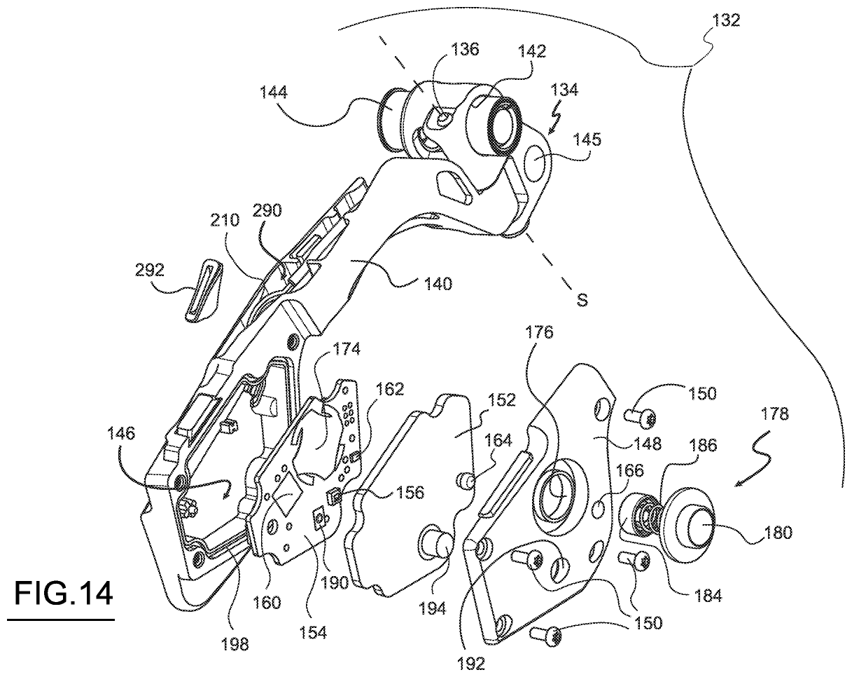

The electronic componentry on the PCB 154 and within the cavity 146 is retained and sealed in place in the cavity. The seal 152 overlies the PCB 154 and is sandwiched between the paddle end 138 and he cover 148 of the shift lever 132 when the cover is fastened to the shift lever. Referring to FIGS. 10 and 14, the seal 152 may include a perimeter rib 196 around the seal material. Likewise, the paddle end 138 may include a groove 198 around the opening into the cavity 146. The rib 196 can seat in the groove 198 to create a tight environmental seal when the cover 148 is secured to the paddle end 138. The material layer of the seal 152 may include raised or thickened regions 200, which may be positioned to coincide with the electrical switches 170, 172, to encourage effective force transfer from the buttons 180, 194 to the switches. The actuation of the electrical switches 170, 172 sends signals through associated circuitry, as is well known, to be acted upon by the controller 160.

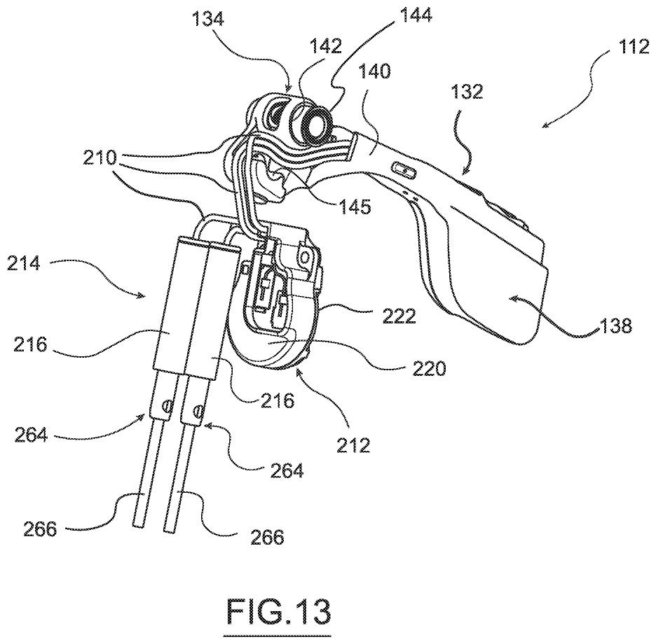

Referring to FIGS. 13 and 14, one or more wires or electrical cables 210 are electrically connected to the electronic componentry of the PCB 154 and are routed from the cavity 146 through an opening into the lever arm 140. The wires 210 extend along the interior of the lever arm 140 and are routed around and between the sleeve 144 and the transverse opening 142 on the proximal end 134 of the shift lever 132. In the disclosed example, the wires are connected to a power supply, i.e., a self-contained battery unit 212. In this example, the shift lever assembly 112 also includes an accessory jack body 214 defining two accessory jacks 216, which are also electrically connected by the wires 210 to the battery unit 212 and to the electronic componentry of the PCB 154. In one example, the jack body 214 can be a single body defining two female accessory jacks 216 therein. Alternatively, each of the accessory jacks 216 can include its own separate body 214 element. The wires 210 thus electrically connect the power supply or battery unit 212 to the accessory jacks 216 and to the electronic componentry of the shift lever assembly 112.

The accessory jacks 216 may be connected to the PCB 154 and/or to a separate accessory PCB (not shown) within the accessory jack body 214. The accessory jack body 214, if provided, can define one or more accessory jacks 216, if desired. A connector for the second control device 101 is configured to be removably connected to the first control device 100 through the accessory jacks 216. The accessory jacks 216 provide power and electrical connection and operation between the second control device 101 and the battery unit 212 and the PCB 154. Shift signals received at the second control device 101 may be transmitted via the cable 402 to the first control device 100 for processing and transmission.

The accessory jacks 216 may be configured to accept connectors from optional additional and/or remote electrical switches or other devices (not shown), such as optionally placed remote shift control buttons on the bicycle 50, to the first control device 100. When no accessories are connected to the first control device 100, the accessory jacks 216 may be closed and/or sealed from moisture and contamination by inserting plugs 218 into the jacks.

The shift lever assembly 112 in this example is thus a self-contained electrical component of the first control device 100. The shift lever 132 and electrical componentry are capable of wirelessly transmitting shift control signals to the front and rear derailleurs 74, 76 according to actuation of the shift lever 132. The battery unit 212 and each accessory jack 216 may be connected by separate wires 210 using a multiple pin connector at the PCB 154. The battery unit 212 and jacks 216 can either have separate connection points to the PCB 154 or can use a cable assembly that starts with a single wire near the PCB and then splits to two or more wires. The battery unit 212 and jack body 214 are each connected to the housing 104 in a unique manner according to the present disclosure.

In this example, referring to FIGS. 12, 15, and 16, the battery unit 212 includes a battery case 220 and a battery cover 222. In an alternate example, the battery unit 212 may house any type of power source. The battery case 220 is received in a recess 224 in the housing 104 and is fixedly attached to the housing via fasteners. In this example, the battery case 220 is fastened to the housing via screws 226, but could similarly be attached to the housing via snap features, adhesive, or another suitable means. A conventional and replaceable coin cell type battery 228 may be received within a battery receptacle 230 defined by the case 220 and open to the exterior of the housing 104. Alternatively, the battery can be a non-replaceable and/or rechargeable battery. The battery 228 may be configured to provide power for the control module 156, the controller 160, and to remote switches or electrical devices via the accessory jacks 216. The cover 222 is rotatable to install over the receptacle 230 and the battery 228 and can be reverse rotated to be removed to access the battery. The cover 222 can include an elastomeric O-ring or gasket 232 around its periphery to create a moisture and contaminant proof seal against the case 220 or the housing 104 when installed. In an alternate example, the battery 228 may be any type of power source.

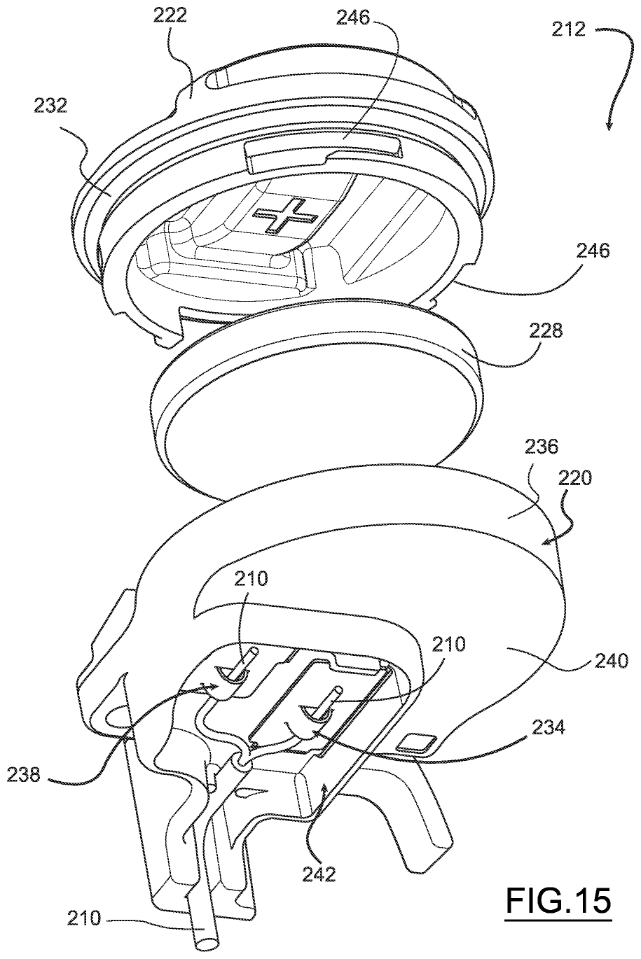

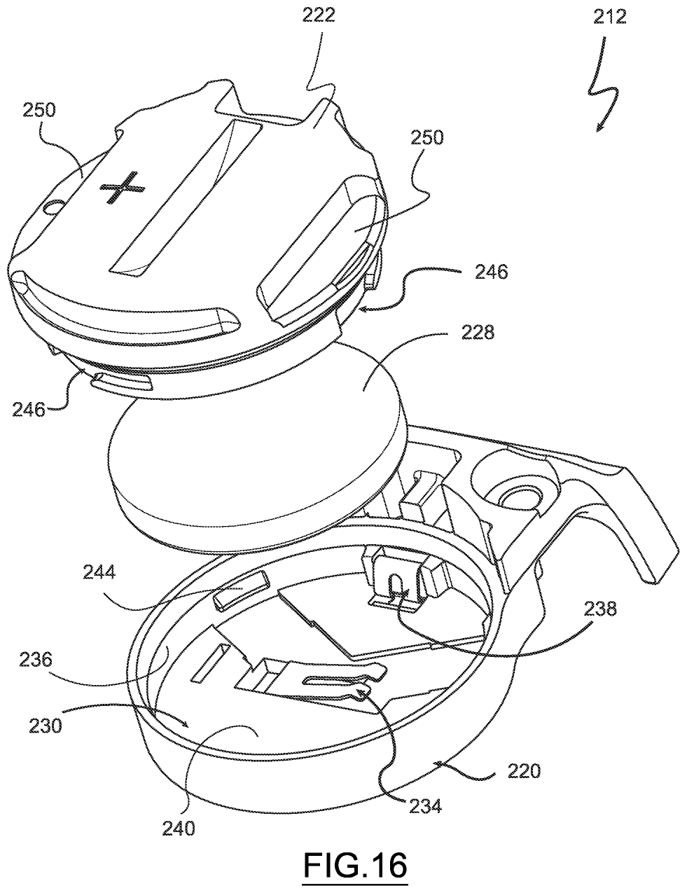

Referring to FIG. 16, the battery receptacle 230 includes a positive contact 324 at a periphery wall 236 of the receptacle and includes a negative contact 238 at the center of the receptacle on a bottom wall 240. Exposed contact portions of the electrical or positive and negative contacts 234, 238 within the battery receptacle 230 contact the corresponding two terminals of the battery 228. Referring to FIG. 15, the battery case 220 also includes a second cavity 242 on a side opposite the battery receptacle 230 and which faces into the housing recess 224 when the case is installed. Portions of the electrical contacts 234 and 238 extend through holes within the case between the battery receptacle 230 and the second cavity 242. Exposed connector portions of the electrical contacts 234, 238 are connected to separate wires 210 within the second cavity 242. These connector portions can be soldered to join the wires 210 and the contacts 234, 238 and the wires can then be connected to the PCB 154. Alternatively, the wires 210 can be crimped or otherwise mechanically secured to the exposed portions of the contacts 234, 238. The positive and negative contacts 234, 238 can be secured to the case via slot features in the wall 236 and bottom 240 of the battery receptacle 230. Alternatively, the contacts could similarly be attached to the case via staking, mechanical fasteners, adhesive, or another suitable means.

During assembly, the second cavity 242, which faces into the recess 224 of the housing 104, is filled with an epoxy that acts to both secure the contacts 234, 238 and wires 210 in place and to create a seal that prevents water and other contaminants from reaching the contacts, the battery 228, the battery receptacle 230, and the interior of the wires 210. This epoxy seal could similarly be provided via a cover piece that is attached to the second cavity 242 via plastic welding, fasteners, adhesive, or another suitable means.

The battery cover 222 may be secured via conventional mechanical threads to the case 220. However, in this example, the cover 222 is secured to the case 220 via a set of tabs 244 or keys and slots 246 or ways that engage one another when the cover is twisted into place. The O-ring 232 is compressed between the cover 222 and the case 220 or a surface of the housing 104 to provides a second seal for the battery receptacle 230 against water and other contamination. The battery cover 222 and/or the case 220 may also contain a series of recesses or depressions 250 on the exposed outer surfaces. The outer cover 122 may include protruding boss features (not shown) on the interior side of the cover that are received in these recesses or depressions 250. When the outer cover 122 boss features are engaged with the recesses or depressions 250, unintentional movement of the battery cover 222 may be inhibited or prevented.

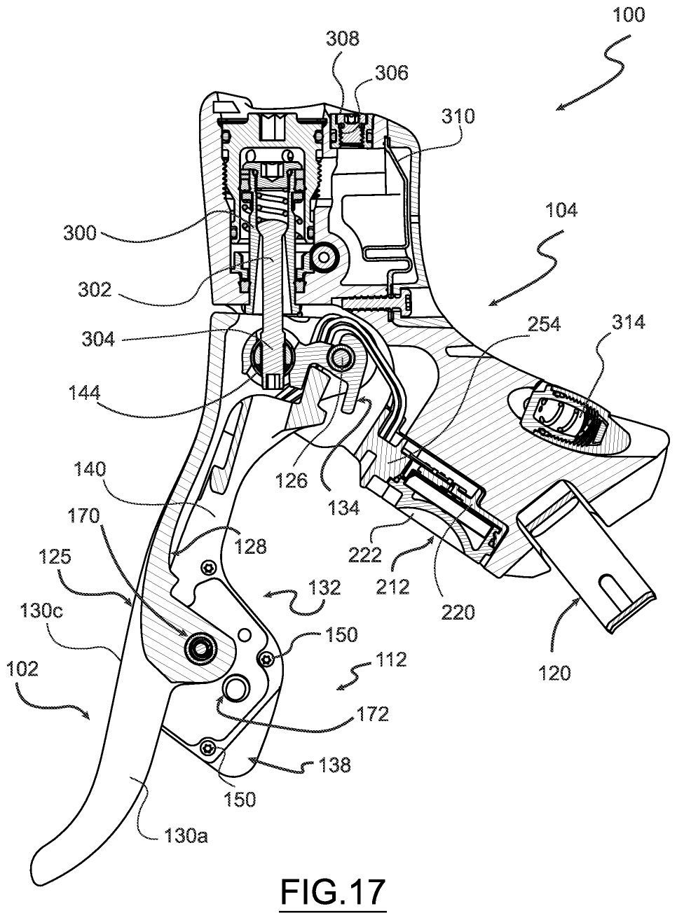

FIG. 17 shows a cross section of the assembled first control device 100. In this example, the battery unit 212 is installed in the recess 224 in the housing 104. The wires 210 between the battery unit 212 and the shift lever 132 are routed via a first channel 252 in the housing 104 above the recess 224. The battery case 220 includes an upper block portion 254 that seats in the first channel 252 to help cover the channel in the assembled first control device 100. The block portion 254 also helps to align the case 220 during installation on the housing 104.

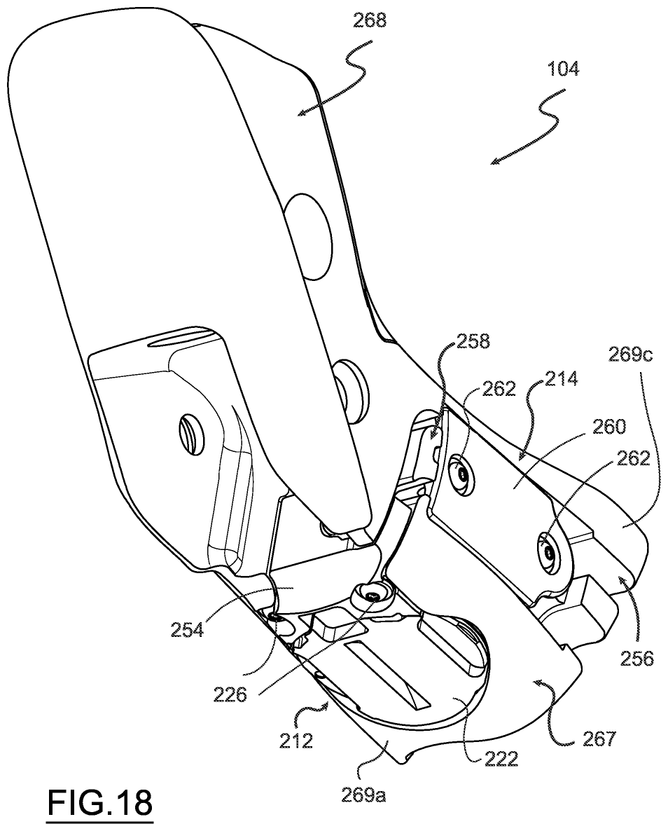

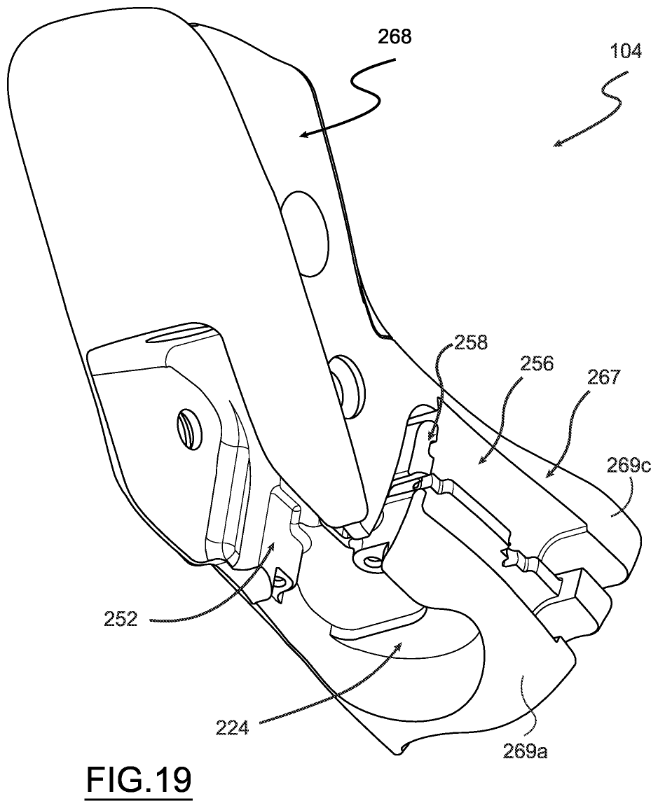

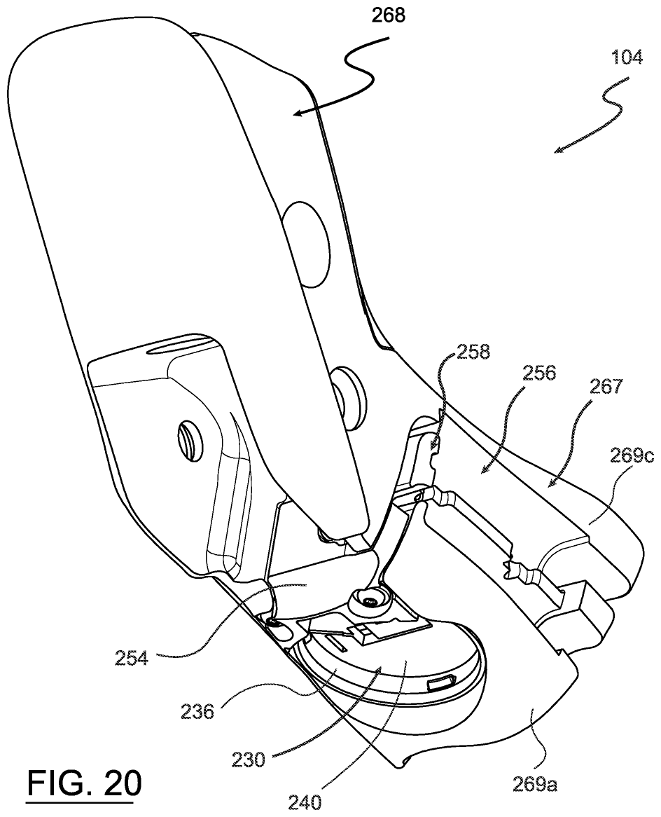

In the disclosed example, the housing 104 may be described as having several sides including an inward facing side, an outward facing side, a bottom side, and a top side. In this example, the battery unit 212 is installed on the bottom side of the housing, as depicted in FIGS. 7, 8, and 17. According to the present disclosure, though the shift lever assembly 112 includes the shift lever 132 and electronic componentry, the accessory jack body 214, and the battery unit 212 as a self-contained assembly, the accessory jack body can be installed on a different side of the housing 104. FIGS. 7 and 18-20 show that the accessory jack body 214 is installed in a jack recess 256 on the inward facing side of the housing 104. A second channel 258 in the housing 104 is disposed above the jack recess 256 for routing the wires 210 from the jack body 214 to the battery unit 212 and PCB 154.

Referring to FIGS. 7, 12, and 18, a jack cover 260 is removably attached to the housing 103 to cover the jack recess 256 to secure and retain the jack body 216 within the jack recess. The jack recess 256 can be shaped to compliment the shape of the jack body 216 or the separate jack bodies of the accessory jacks 216. The accessory jacks 216 in this example are female jacks with access openings (not shown) located on and accessible from the external surface of the housing 104. The accessory jacks 216 provide an interface between the second control device 101, and/or optional remote shift control button assemblies, and the shift control system including the shift lever assembly 112. In one example, two or more accessory jacks could be combined into a single assembly with a single cable assembly emanating to the battery unit 212 and PCB 154. In this example, the jack body 214 is fixedly attached to the housing 104 via the jack cover 260 that is fastened to the housing with screws 262. The jack body 214 could instead be attached to the housing via snap features, adhesive, or other suitable means. The jack body 214 could also be non-permanently fixed to the housing such that the jack body or accessory jacks 216 can be lifted out of the housing when not covered by the jack cover 260.

Though not shown herein, the jack body 214 for each accessory jack 216 can have two cavities including an interior cavity located closer to the shift control system and separated from an external cavity, which defines a plug interface or connector receiver for receiving a connector for the second control device 101 and/or an accessory component. Each plug interface can function, when in use, to retain a second control device connector therein and to electrically connect the connector terminal to one end of a wire or cable assembly that terminates at the PCB 154 at the other end. The terminal or terminals can extend from the external cavity to the internal cavity for each accessory jack 216 and be connected to the wire or wires. The internal cavity is filled with an epoxy, similar to the battery case second cavity 242. The epoxy can secure the wires in place and create a seal that prevents water and other contaminants from reaching the internal cavity, the cable, or wires therein, the plug interface, and the external cavity. Such a seal could instead be provided by molding the jack body or a separate interface piece over the exterior of the wire connections and jack body.

Referring to FIGS. 7, 11, 12, 13, and 21 when not being used, the accessory jacks 216, and particularly the exterior cavities, can be closed or plugged by inserting a plug 264 into each of the access openings. The plugs 264 are inserted into the jack body's external cavities. A seal can be created via an elastomeric O-ring (not shown) that is compressed between the exterior of the plug 264 and the inner wall of the externa cavities. The plug seal prevents water and contaminants from reaching the electrical interface and parts within the jack body 214. The connectors for remote accessories can look and function similar to the plugs 264, except that each connector would make electrical contact with a terminal or terminals within the external cavities. The plugs 264 can include an extension or tail 266 that protrudes from the accessory jacks 216 so that the plugs can be easily grasped and pulled from the jack body 214 when needed.

Referring to FIGS. 17-21, the housing 104 can be formed having a base portion 267 and an extension portion 268. The base portion 267 can include first and second or rear facing and front facing ends, a downward facing side 269a, an upward facing side 269b, an inward facing side 269c, an outward facing side 269d. The handlebar clamp 120 in this example is disposed at the first or rear facing end. When the first control device 100 is mounted to a bicycle handlebar 64, the base portion 267 extends generally horizontally and the extension portion 268 extends forwardly of the base portion at the second end and is angled generally upwardly from the base portion.

The inward facing side 269c and an outward facing side 269d, the inward facing side being closer to the center of the bicycle frame 52 when the housing 104 is mounted on the handlebar 64. In this example, the remote shift control accessory jacks 216 are located on the inward facing side 269c of the base portion 267 of the housing 104. However, the jacks could instead be positioned on the outward facing side 269d, or on both sides. Further, in this example, the battery recess 224 in the housing, and thus the battery case 220, are disposed on the downward facing side 269a on the base portion 267. One or more electrical wires 210 extend from the top of the jack body 214 and between the accessory jacks 216 and the PCB 154. The wires 210 are compressed into and routed via the second channel 258 in the housing 104 above the jack recess 256 toward the wires of the battery unit 212. The wires 210 are then routed toward the PCB 154 along with the wires for the battery unit 212. The jack cover 260 can also have a gasket or seal that creates tight seal between the cover and the housing 104 when installed. The battery case 220, when secured to the housing 104, also has features that secure the wires 210 by compressing the wires between the battery case and the housing. The battery case 212 also has a guide feature, i.e., the block portion 254 that guides the wires from the exterior to the interior of the housing 104.

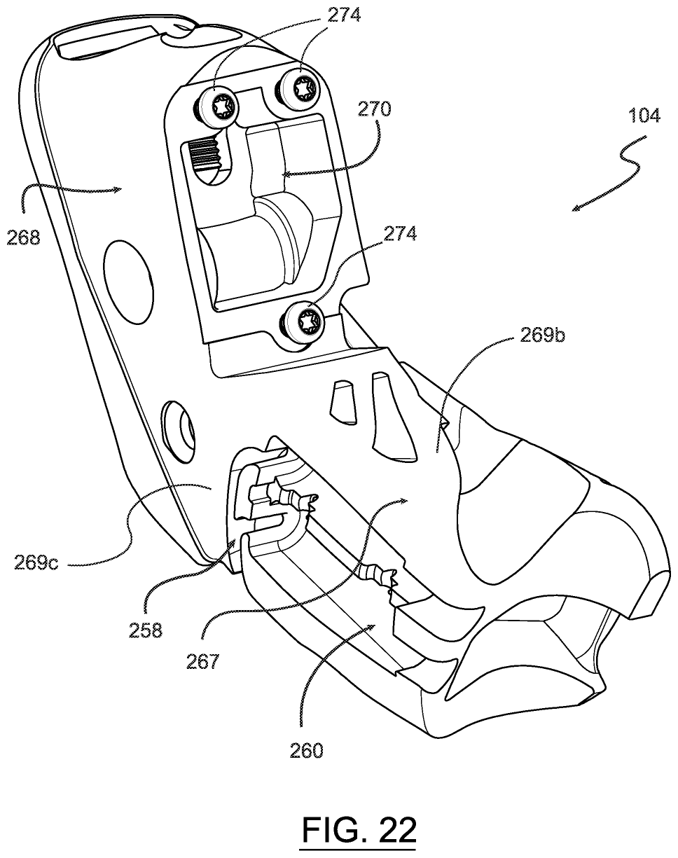

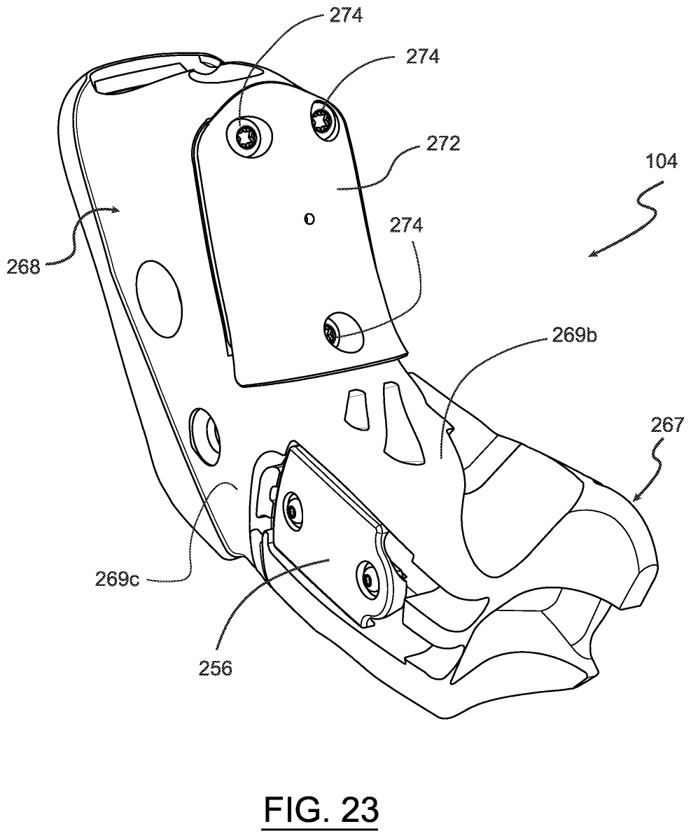

FIGS. 22 and 23 show a top view of the housing 104 with the outer cover 122 removed. FIG. 22 shows a chamber 270 in the housing where the brake lever 102 is connected to the hydraulic brake system components. The chamber 270 is accessible via a removable chamber cover 272, which is depicted in FIG. 23. The chamber cover 272 can be secured to the housing 104 by screws 274 or other fasters, snap connections, adhesive, or other suitable securing means. Though not described in significant detail herein, the chamber 270 may house and provide access to components of the first control device 100 for maintenance or adjustment. When the outer cover 122 is attached to the housing 104, the chamber cover 272, jack cover 260 and battery cover 222 may all be covered and hidden and be protected from the environment.

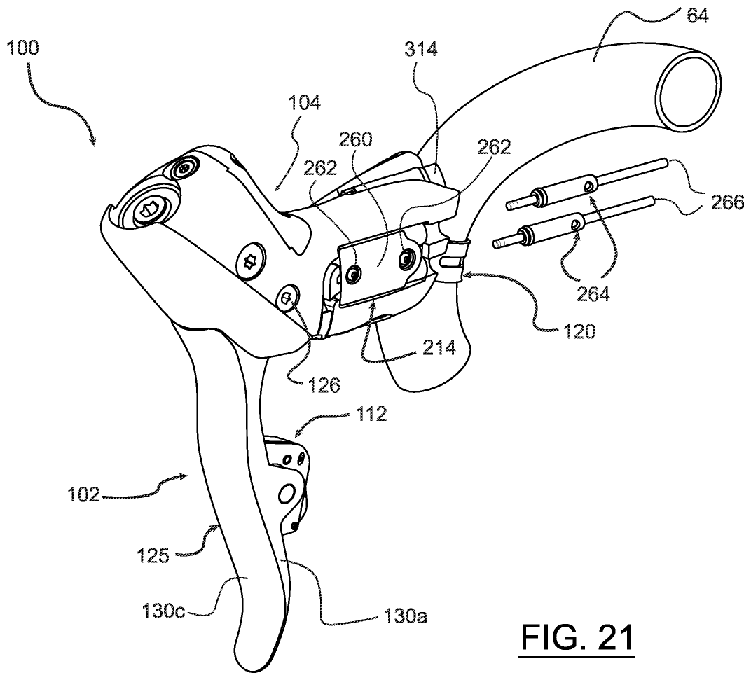

Referring to FIG. 17, the hydraulic brake system may generally include a housing bore with a master cylinder sleeve 300 inserted into the bore and configured to act as a master cylinder for the brake system. A piston 302 resides in and moves relative to the sleeve 300. The piston 302 includes one end 304 coupled to the brake lever 102 and is operable by movement of the brake lever as is known in the art. The master cylinder sleeve 300 is in fluid communication with the chamber 270, which can act as a brake fluid chamber for the brake system. The chamber 270 can include a bleed port 306 and a bleed screw 308 movable in the bleed port to fill, top off, or bleed hydraulic fluid of the brake system via the chamber 270. In this example, a compliant or flexible membrane 310 may be provided over and closing off the open side of the chamber 270 to provide a defined fluid chamber having a variable volume. The membrane 310 may be positioned between the cover 272 and the open side of the chamber 270, as depicted in FIG. 17. Referring to FIGS. 11 and 21, the housing 104 of the first control device 100 may include a fluid outlet port 312 in communication with the master cylinder sleeve 300. As force is applied to move the brake lever 102, fluid may be forced to the fluid outlet port. 312. The housing 104 of the control device may also include a control device fluid outlet 314 that is in fluid communication with the fluid outlet port 312. A hydraulic brake line 110 may be connected to the control device outlet port 314 and to the front or rea brake mechanism 106 or 108 for operation as is known in the art. In one example, the chamber cover 272 may be removed to replace or repair the flexible membrane 310.

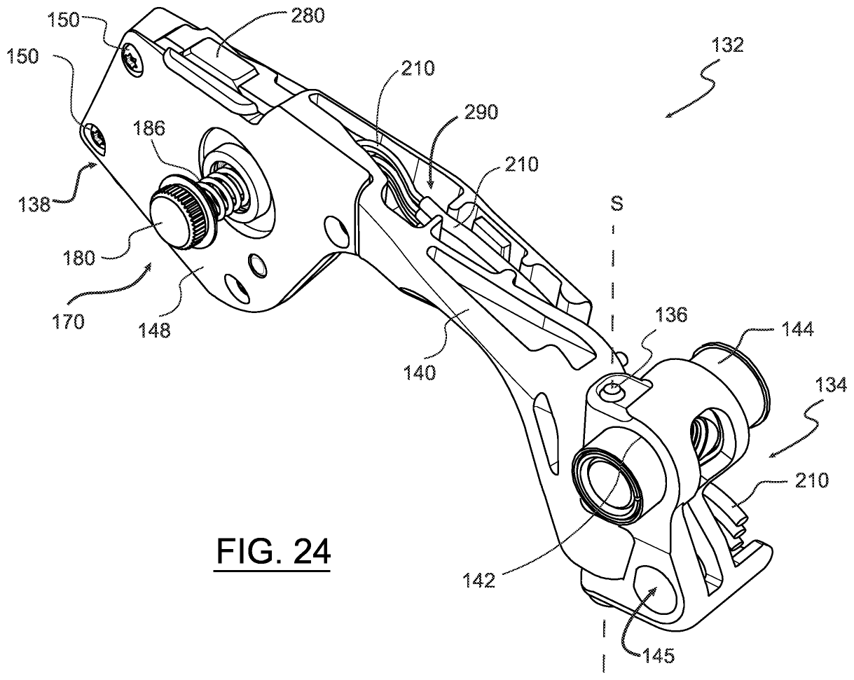

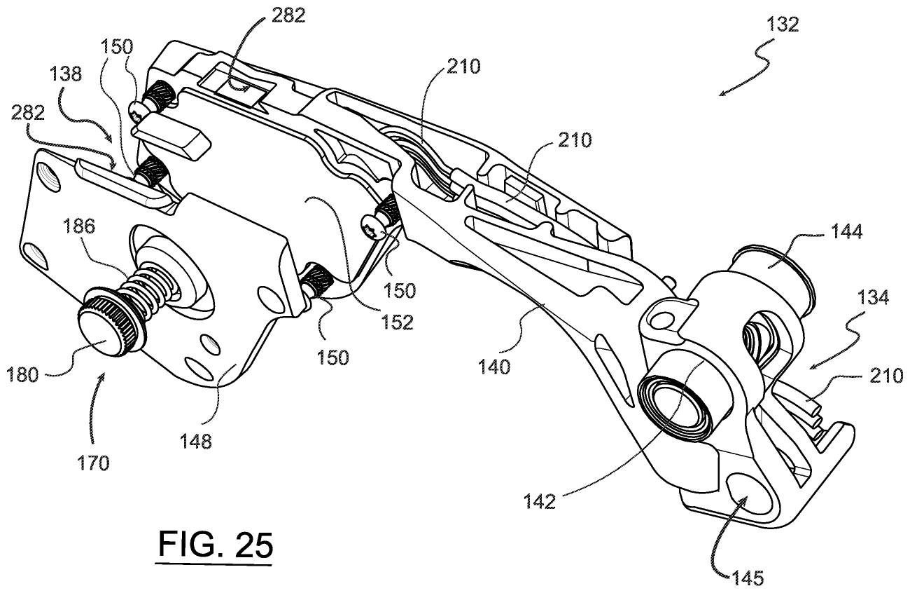

FIGS. 24 and 25 show another aspect of the first control device 100 according to the disclosure. In this example, a backer 280 can be inserted between and sandwiched by the cover 148 and the paddle end 138 of the shift lever 132. Each part can be formed to define a receiving portion, such as a pocket 282, that captures an edge of the backer 280. The backer 280 can create a contact point between the top of the shift lever 132 and a contact surface on the inside surface of the brake lever front wall 130c, as shown in FIG. 9. The contact surface can include a bump or protrusion 284 positioned to contact the backer 280. The backer 280 is essentially captured between the bump 284 on the brake lever inside surface 130c and the pocket 282 on the shift lever 132. The backer 280 can be formed from a durable material with low friction characteristics. In one example, the backer 280 can be made from a material different from the shift lever, such as Teflon, and then can be attached to the shift lever. The backer 280 can thus allow the shift lever 132 to slide laterally and easily relative to the brake lever 102 to inhibit binding and wear.

In the disclosed first control device 100, the interior cavity 146 of the shift lever 132 contains the shift control system PCB 154 and a separate arm cavity 290, which extends along the lever arm 140. The lever arm 140 can be open along a forward side that is oriented facing the brake lever front wall 130c. The opening can open to the arm cavity 290, guides and retains the electrical cable assembly or wires 210 extending between the PCB 154 and the battery unit 212 and accessory jacks 216. The interior cavity 146 and the arm cavity 290 are joined via an internal hole (not shown) in the interior of the shift lever 132. These cavities could instead be joined via a slot. The cover 148 is fastened to the paddle end 138 of the shift lever 132, as described below, to provide a seal that prevents water and other contaminants from reaching the PCB 154. The electrical cable assembly, which consists of one or more independent wires 210, passes through the hole between the interior cavity 146 and the arm cavity 290. The arm cavity 290 is also filled with epoxy during assembly to both secure the wires 210 in place and provide a seal that prevents water and other contaminants from accessing the interior of the cable assembly and wires, the PCB 154, and the interior cavity 146.

As shown in FIG. 14, prior to the application of epoxy to the arm cavity 290, an epoxy blocker piece 292 can be installed at the location, i.e., the hole between the interior cavity 146 and the arm cavity 290. The epoxy blocker piece 292 provides a temporary seal that prevents epoxy from flowing into the circuit board cavity before solidifying. Once the shift lever assembly 112 is installed with the brake lever 102, the epoxy filled opening along the lever arm 140 faces the front wall 130c of the brake lever so that it would not be readily visible.

FIGS. 26-29B show the electronic shift control system 400, including the second control device 101 in relation to the first control device 100. As seen in FIG. 26 from the underside of the handlebars 64, the first control device 100 may be operated by a user's right hand while the second control device 101 may be operated by a user's left hand. A cable 402 connects the second control device 101 to the first control device 100.

The first bicycle control device 100 is configured to wirelessly transmit both a first signal and a second signal. The first signal is generated by the first bicycle control device 100 and the second signal is generated by the second control device 101.

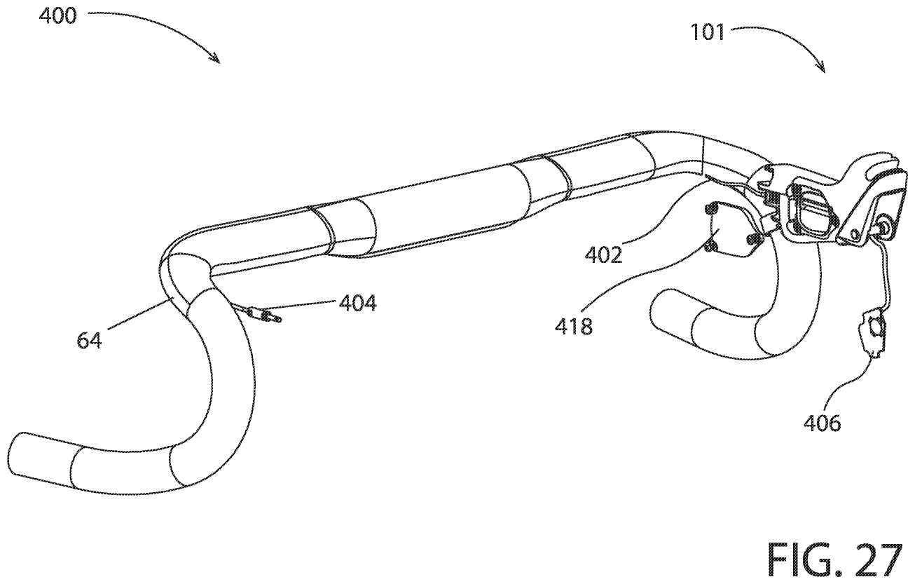

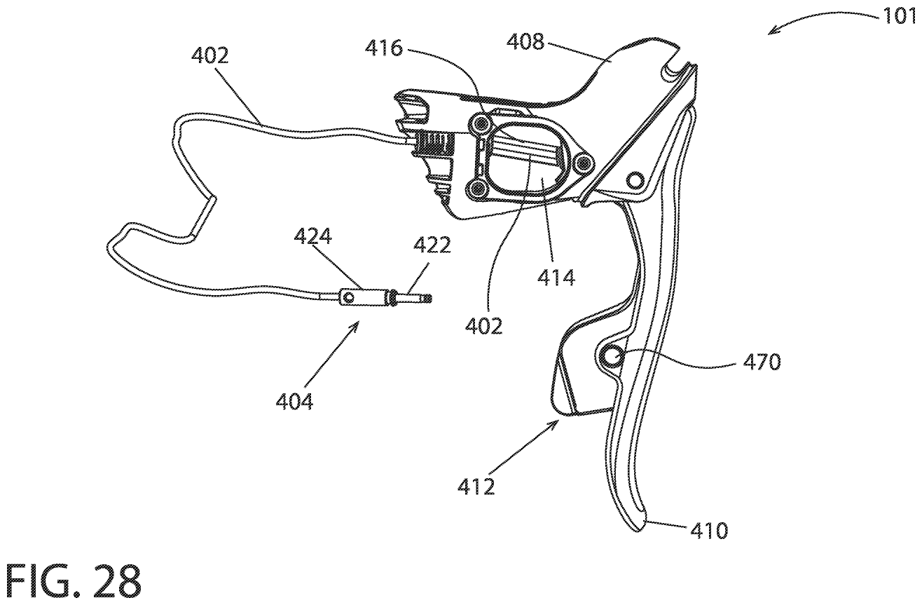

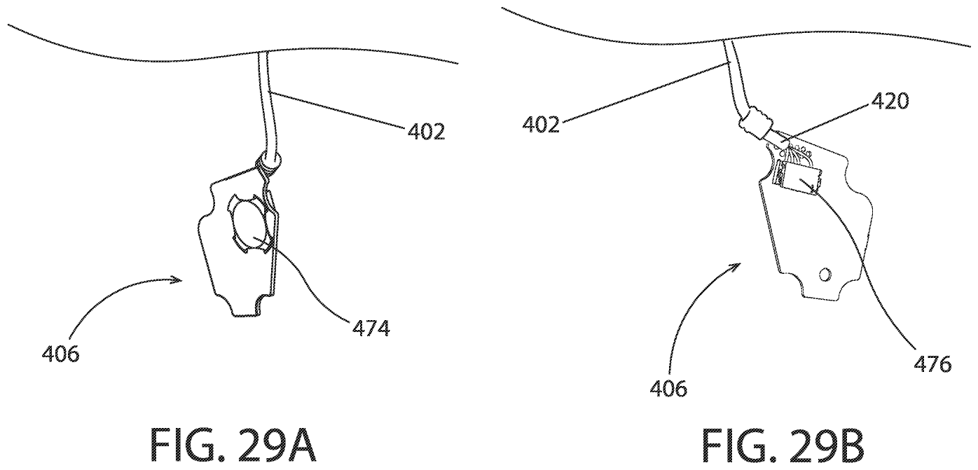

FIG. 27 shows a perspective view of the second control device 101 on the handlebar 64 without a shift lever assembly 412 and without a brake lever 410. Further, in FIG. 27 the jack cover 418 is shown detached from the housing 408 of the second control device 101. FIG. 28 shows a side view of the second control device 101 without the jack cover 418. FIGS. 29A and 29B show a first side and a second side of the PCB 406 located within the shifter assembly 412.

As seen in FIGS. 27-29B, the cable 402 includes a connector 404 at an end connecting to the first control device 100. The connector 404 is configured to connect directly into one of the accessory jacks 216 of the first control device 100. The second end of the cable 402 includes an attachment section 420 that connects directly onto a PCB 406 via an electrical connector 476 located on the PCB 406. The attachment section 420 may be a circuit board connector.

The connector 404 includes an insertable connective portion 422 and a connector casing 424. The cable 402 may be any cable construction operative to communicate control signals of the first or second control devices 100, 101. In an embodiment, the cable may include at least one conductive wire for communicating the control signals and power between the first control device 100 and the second control device 101. The connector casing 424 may be made of any material operable to insulatingly house a communicative connection between the cable 402 and the insertable connective portion 422. For example, the connector casing 424 may be made of a thermoplastic engineering polymer or polyesters, such as polybutylene terephthalate (“PBT”) or glass filled PBT. The insertable connective portion 422 may be made of conductive materials so as to be operable to conduct signals. For example, the insertable connective portion 422 may be made all or mostly of a conductive metal, such as steel, copper, or aluminum, as well as other metals or combinations thereof. The connector 404 may be a DC jack assembly. An O-ring may be used in conjunction with a sealing mechanism of the connector casing 424 to prevent the ingress of water and contaminants.

When the jack cover 418 is removed, as seen in FIG. 28, the cable 402 can be seen within the housing 408, routed by a cable routing mechanism 416 through the cavity 414. In the example, the cable routing mechanism 416 may be anything to help position and route the cable through the housing 408 and down to the shift lever assembly 412, such as a rod, tube, channel, etc. The cable routing mechanism is an optional feature of the present disclosure.

FIG. 28 also shows an electrical switch 470 that is configured to be actuated by a user in an identical manner as electrical switch 170. The electrical switch 470 actuates a dome switch element 474 on the PCB 406.

The second control device 101 is identical to the first control device 100 in many ways. However, as seen in FIGS. 26-29B, the second control device 101 includes less components than the first control device 100. Specifically, the second control device 101 does not include a battery unit. Additionally, the PCB 406 of the second control device is a bare PCB 406. The bare PCB 406 includes only a dome switch element 474 on a first side and an electrical connector 476 on a second side. The dome switch element 474 may be a snap-dome switch. The dome switch element 474 may be gold plated. When a user actuates the electrical switch 470, the dome switch element 474 is depressed. The signal generated from the electrical switch 470 is transmitted through the wire 402 to the PCB 154 for wireless transmission.

As the first bicycle control device 100 includes wireless transmission capabilities, and the second bicycle control device 101 does not, the first bicycle control device 100 may be at least partially made of a first material while the second bicycle control device 101 may be made of a different material than the first material. The first material may be a radio-frequency transparent material. The first material may be plastic, glass filled nylon, or carbon filled nylon.

The disclosed first control device 100 and the shift lever assembly 112 is configured such that the shift control system and battery unit are separated from the accessory jacks, even though the electronics are formed as one self-contained piece. The configuration results in several benefits. Also, the battery unit can be placed on a different side of the housing than the accessory jacks, which enables the use of a twisting battery cover with a deep coin slot. Further, the accessory jacks, battery unit, and primary shift control button assembly are all independently sealed against ingress of water or contaminants. Thus, moisture and contaminants are not able to travel from one subassembly to another within the device. Still further, no circuit board is exposed when the removable seals for the battery cover and accessory jacks are not in place. Thus, it is not possible for water or contaminants to damage the electrical shift control system when these seals are removed.

Another advantage is that the electrical cables or wires for the various components on the sides of the housing are routed around the exterior of the housing. This can improve the strength of the housing and can allow for complete assembly and installation of the electrical system components prior to installation on the housing. Still further, the shift control system only requires one circuit board located in the shift lever. Also, an epoxy seal is used at the interface of the electrical cables or wires and the shift control circuit board in the shift lever. This allows a multiple pin connector piece used to secure the wires to the circuit board to be installed prior to installing the cables or wires in the shift lever.

Although certain bicycle control device examples, features, aspects, components, and characteristics have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An electronic shift control system for a bicycle, comprising:
a first bicycle control device, the first bicycle control device including:
a first housing,
a first brake lever, and
a first switch configured to generate a first signal when actuated; and
a second bicycle control device, the second bicycle control device including:
a second housing,
a second brake lever, and
a second switch configured to generate a second signal when actuated,
wherein the first bicycle control device is configured to wirelessly transmit both the first signal and the second signal.

2. The electronic shift control system of claim 1, wherein the first bicycle control device includes a first circuit board configured for wireless communication.

3. The electronic shift control system of claim 2, wherein the first circuit board includes an antenna.

4. The electronic shift control system of claim 3, wherein the first bicycle control device includes an accessory jack for receiving at least one connector, the accessory jack configured to communicate with the first circuit board.

5. The electronic shift control system of claim 4, further comprising:
a cable, the cable having a circuit board connector at a first end and a connector at a second end.

6. The electronic shift control system of claim 5, wherein the second bicycle control device includes a second circuit board, the second circuit board having a first side and a second side.

7. The electronic shift control system of claim 6, wherein the first side includes the second switch.

8. The electronic shift control system of claim 7, wherein the second switch is a snap-dome switch.

9. The electronic shift control system of claim 6, wherein the second side includes an electrical connector configured to connect with the circuit board connector of the cable.

10. The electronic shift control system of claim 9, wherein the connector of the cable is configured to be connected to the accessory jack, communicating the second signal to the first bicycle control device for wireless transmission by the first bicycle control device.

11. The electronic shift controls system of claim 10, wherein the first bicycle control device includes a power source.

12. The electronic shift controls system of claim 11, wherein the power source is a battery.

13. The electronic shift controls system of claim 12, wherein the power source is configured to provide power to the first bicycle control device and the second bicycle control device via the cable.

14. The electronic shift control system of claim 3, wherein the first bicycle control device is at least partially made of a first material.

15. The electronic shift control system of claim 14, wherein the first material is a radio-frequency transparent material.

16. The electronic shift control system of claim 15, wherein the first material is at least one of plastic, glass filled nylon, or carbon filled nylon.

17. The electronic shift control system of claim 16, wherein the second bicycle control device is made of a different material than the first material.
